(19) United States
(12) Patent Application Publication
(10) Pub. No.: US 2025/0337008 A1
(43) Pub. Date: Oct. 30, 2025

(54) SOLID POLYMER ELECTROLYTES FOR SOLID-STATE LITHIUM METAL SECONDARY BATTERIES

(71) Applicant: Evonik Operations GmbH, Essen (DE)

(72) Inventors: Feifei Wang, Shanghai (CN); Xiaochuan Xu, Shanghai (CN); Jing Feng, Shanghai (CN); Xiaowei Tian, Shanghai (CN); Minghui Chen, Shanghai (CN); Jun Yang, Shanghai (CN); Yixi Kuai, Shanghai (CN); Huichao Lu, Shanghai (CN); Zhixin Xu, Shanghai (CN)

(73) Assignee: Evonik Operations GmbH, Essen (DE)

(21) Appl. No.: 18/689,891

(22) PCT Filed: May 25, 2021
(86) PCT No.: PCT/CN2021/095863

§ 371 Date: Mar. 7, 2024

(51) Int. Cl. H01M 10/0565; H01M 10/0525; H01M 50/636

(52) U.S. Cl. CPC H01M 10/0565; H01M 10/0525; H01M 50/636; H01M 2300/0082; H01M 2300/0085

(57) ABSTRACT

A silica composition can be used in preparation of solid polymer electrolytes, wherein the silica composition has a surface-modified colloidal silica dispersion, or an evaporated product of the dispersion. A polymer electrolyte precursor composition for preparation of a solid polymer electrolyte, use of the polymer electrolyte precursor composition in preparation of a solid polymer electrolyte, a method to in-situ prepare a solid polymer electrolyte, a method to improve performance of a lithium-ion battery, a solid polymer electrolyte, an electrochemical device and a device are also described.

### TECHNICAL FIELD

The present invention relates to solid polymer electrolytes, specifically, a hybrid solid polymer electrolyte with high ionic conductivity suitable for solid-state lithium ion battery, especially lithium metal secondary batteries at room temperature.

### BACKGROUND ART

With the development and requirement of various energy storage devices and system especially for electric vehicles, traditional Li-ion batteries can no longer meet market's needs and there is an urgent need of high-energy/power-density lithium batteries. Lithium ion batteries employing Li metal (−3.04 V vs. standard hydrogen electrode, 3860 mAh g⁻¹) as anode and high voltage LiNiₓCo_{y}Mn_{1-x-y} (≥4.3 V vs. Li⁺/Li, ≥150 mAh g⁻¹) as cathode are commonly recognized as the next generation of lithium ion batteries. Except for electrodes, as one of the most important part of the lithium ion batteries, electrolytes also play a very important role in the state-of-the-art Li-based lithium ion batteries. Unfortunately, conventional organic liquid electrolytes employing carbonate or ether-based solvents exhibit limited electrochemical stability window (less than 4.3V vs. Li/Li⁺), which makes them highly unstable against novel high-voltage cathodes. Besides, commercial electrolytes contain large amount of organic component which are volatile and flammable. Therefore, solid polymer electrolytes (SPEs) are attracting more attentions for its lower safety risks, wide electrochemical stability window and the ability to suppress lithium dendrites. However, most SPEs still show poor ionic conductivity at room temperature (<10⁻⁵ S cm⁻¹), which significantly hinders their practical application.

One preferred solution is to introduce nanosized inorganic fillers to obtain hybrid polymer electrolytes, which already attracted great interest, because they can effectively enhance not only ionic conductivity but also mechanical properties of electrolytes. The inorganic fillers are generally divided into two basic types: inert ceramic powders/non-active fillers (e.g. silicon dioxide nanoparticles, i.e. silica nanoparticles) and active fillers (e.g. NASICON and garnet oxide fillers). Although the polymer-inorganic hybrid electrolytes with additional inorganic fillers (like PVC-LiClO₄ with TiO₂ fillers) are proved to improve the ionic conductivity without sacrificing the mechanical strength, several issues still need to be solved, including the agglomeration of ceramic fillers and weak interaction between fillers and polymers.

### SUMMARY OF THE INVENTION

The inventors surprisingly found that by adding the filler of surface-modified colloidal silica nanoparticles, the performance such as ionic conductivity of solid polymer electrolytes (such as poly vinyl ethylene carbonate-based, PEO based polymer electrolytes) has been improved significantly at room temperature (>10⁻⁴ S cm⁻¹ for ionic conductivity), and the performance of a lithium ion battery comprising the solid polymer electrolyte such as cycle performance has been improved as well.

Such surface-modified colloidal silica nanoparticles further exhibit excellent dispersion and good polymer-filler interaction in solid polymer electrolytes and can be used as additives in polymer electrolytes to improve the performance of Li-ion batteries.

The invention provides use of a silica composition in preparation of a solid polymer electrolyte, especially to improve the performance of the solid polymer electrolyte such as ionic conductivity and/or the performance of a lithium ion battery comprising the solid polymer electrolyte such as cycle performance, wherein the silica composition comprises or consists of:
a surface-modified colloidal silica dispersion, or an evaporated product of the dispersion.

As used herein, the term “surface-modified” in the invention refers to “organically surface modified”; the term “surface-modified colloidal silica dispersion” refers to a colloidal silica dispersion wherein the silica is organically surface modified. The silica may be modified by organic compounds including organic silicon compounds such as silane.

In the invention, the silica is surface modified, especially by silane, e.g. organofunctional silanes, especially alkoxy silanes.

In the invention, the term “solid polymer electrolyte” refers to all-solid-state polymer electrolyte and/or quasi-solid-state polymer electrolyte.

In the invention, the colloidal silica dispersion is not an unstable suspension of silica particles. Typically, the colloidal silica dispersion is a homogeneous and stable dispersion of silica particles. In some embodiments, the colloidal silica dispersion is transparent or clear.

As used herein, the term “evaporated product of the dispersion” refers to the evaporated product of the colloidal silica dispersion wherein the solvent of the colloidal silica dispersion is evaporated, preferably under reduced pressure (e.g. vacuum), preferably before (e.g. 0.01-24 hours before) it is used in preparation of solid polymer electrolytes. Such evaporated product of the dispersion is solid. Using the silica composition of the invention, the silica particles can be evenly dispersed in the electrolyte. The evaporated product of the dispersion is preferably essentially consisting of nano-sized silica. Typically, the evaporated product of the dispersion is an evaporated product of a colloidal silica dispersion that comprises one or more non-polymerizable volatile organic solvents. In such case, when the non-polymerizable volatile organic solvents are evaporated, basically only silica is left in the evaporated product.

In some embodiments, the silica composition is a surface-modified colloidal silica dispersion. In some embodiments, the silica composition is an evaporated product of a surface-modified colloidal silica dispersion.

The silica of the invention is preferably nano-sized silica, which has an average particle size between 1 and 100 nm. The average particle size of the silica typically is between 3 and 50 nm, preferably 5-40 nm, more preferably 8-30 nm. The average particle size of the silica is preferably measured by means of small-angle neutron scattering (SANS).

Typically, the average particle size of the silica as measured by means of small-angle neutron scattering (SANS) is between 3 and 50 nm, preferably 5-40 nm, more preferably 8-30 nm, and wherein the colloidal silica is organically surface modified, especially by silane.

In some embodiments, the average particle size of the silica as measured by means of small-angle neutron scattering (SANS) is between 3 and 50 nm, preferably 5-40 nm, more preferably 8-30 nm, e.g. at a maximum half-width of the distribution curve of 1.5 dₘₐₓ.

In some embodiments, the average particle size dₘₐₓ of the silica nanoparticles is between 6 and 100 nm, preferably 6 and 40 nm, more preferably 8 and 30 nm, more preferably 10 and 25 nm.

In some embodiments, the maximum width at half peak height of the distribution curve of the particle size of the silica nanoparticles is not more than 1.5 d max, preferably not more than 1.2 d max, more preferably not more than 0.75 d max.

In some embodiments, the silica particles are substantially spherical. Preferably the particles have a spherical shape.

In some embodiments, the silica composition is
a colloidal silica dispersion, which comprises or consists of:
a) surface-modified silica particles, and
b) a polymerizable solvent, which is selected from monomers, oligomers and/or prepolymers convertible to polymers by nonradical or radical reactions;
or
an evaporated product of a surface-modified colloidal silica dispersion comprising or consisting of:
a) surface-modified silica particles, and
b′) a non-polymerizable volatile organic solvent;
wherein the average particle size of the silica is between 3 and 50 nm, preferably 5-40 nm, more preferably 8-30 nm.

In such colloidal silica dispersion, the surface-modified silica particles are homogenously dispersed in the polymerizable solvent or the non-polymerizable volatile organic solvent and form a colloidal silica dispersion. In other words, such colloidal silica dispersion may be a homogeneous silica dispersion in the non-polymerizable volatile organic solvent, or the polymerizable solvent.

The polymerizable solvent is preferably versatile.

In some embodiments, the silica composition is a surface-modified colloidal silica dispersion comprising or consisting of surface-modified silica particles and a polymerizable solvent selected from monomers, oligomers and/or prepolymers convertible to polymers by nonradical or radical reactions. The polymerizable solvent is preferably able to copolymerize with the monomer of the polymer forming the polymer matrix of the solid polymer electrolyte.

In some embodiments, the silica composition is an evaporated product of a surface-modified colloidal silica dispersion comprising or consisting of surface-modified silica particles and a non-polymerizable volatile organic solvent. In such case, the non-polymerizable volatile organic solvent is evaporated, thus the evaporated product of the surface-modified colloidal silica dispersion may essentially consist of the surface-modified silica particles.

In some embodiments, the amount of component a) above is from 10 wt. % to 80 wt. %, preferably from 30 wt. % to 60 wt. %, based on the total weight of the colloidal silica dispersion.

In some embodiments, the amount of component b) above is from 20 wt. % to 90 wt. %, preferably from 40 wt. % to 70 wt. %, based on the total weight of the colloidal silica dispersion.

In some embodiments, the colloidal silica dispersion further comprises: c) a polymer, which is preferably polymerizable with the polymerizable solvent of component b).

In some embodiments, the silica composition is the silica dispersion according to WO 02/083776A1, which is incorporated herein in its entirety by reference.

In some embodiments, the silica composition is a silica dispersion, which comprises:
aa) an external fluid phase comprising
   aa1) polymerizable monomers, oligomers and/or prepolymers convertible to polymers by nonradical reactions;
   and/or
   aa2) polymers,
bb) a disperse phase comprising silica, and the average particle size of the silica as measured by means of small-angle neutron scattering (SANS) is between 3 and 50 nm at a maximum half-width of the distribution curve of 1.5dₘₐₓ.

The external fluid phase may comprise a polymer or two or more polymers. Polymers in this sense are macromolecules which are no longer reactive and which therefore do not react to form larger polymer units.

The fraction of the external phase as a proportion of the dispersion can in the context of the invention be between 20% and 90% by weight, preferably from 30% to 80% by weight, more preferably from 40% to 70% by weight. In some embodiments, said external fluid phase is from 30% to 70% by weight of said dispersion.

In some embodiments, said external fluid phase comprises at least one substance selected from the group consisting of polyols, polyamines, linear or branched polyglycol ethers, polyesters, and polylactones.

In some embodiments, said external fluid phase comprises at least one reactive resin.

In some embodiments, one or more of said polymerizable monomers, oligomers, or prepolymers comprise main chains, and wherein said main chains comprise one or more C, O, N or S atoms.

In the polymerizable solvent of the invention, prepolymers are relatively small polymer units which are able to crosslink and/or polymerize to form larger polymers. “Polymerizable” means that in the composition, especially the external phase there are still polymerizable and/or crosslinkable groups which are able to enter into a polymerization reaction and/or crosslinking reaction in the course of further processing of the dispersion. In some embodiments, the external phase comprises polymerizable constituents which are convertible to polymers by non-radical reactions. This means that the polymerization to polymers does not proceed by way of a free-radical mechanism. Preference is given instead of this to polycondensations (polymerization occurring in stages with the elimination of secondary products) or polyadditions (polymerizations proceeding in stages without elimination of secondary products). Likewise provided by the invention are anionic or cationic polymerizable constituents in the external phase. In some embodiments, the dispersion does not have an external phase which comprises polymerizable acrylates or methacrylates as a substantial constituent. In some embodiments, the dispersion has an external phase which comprises polymerizable acrylates or methacrylates as a substantial constituent.

Polymerizable acrylates or methacrylates are all monomeric, oligomeric or prepolymeric acrylates or methacrylates which in the course of the production of a material from the dispersion are deliberately subjected to a further polymerization. One example of the polyadditions is the synthesis of polyurethanes from diols and isocyanates, one example of polycondensations is the reaction of dicarboxylic acids with diols to form polyesters.

As external phase, furthermore, it is also possible in accordance with the invention to use monomers and oligomers. These include in particular those monomeric or oligomeric compounds which can be reacted to form polymers by polyaddition or polycondensation.

In one preferred embodiment of the invention the polymerizable monomers, oligomers and/or prepolymers contain carbon, oxygen, nitrogen and/or sulfur atoms in the main chain. The polymers are therefore organic hydrocarbon polymers (with or without heteroatoms); polysiloxanes do not come under this preferred embodiment. The external fluid phase may preferably comprise polymerizable monomers without radically polymerizable double bonds and also reactive resins.

In some embodiments, the polymerizable solvent is selected from polymerizable acrylates or methacrylates.

Examples of polymerizable solvent include but are not limited to: functional acrylates, including:
monofunctional acrylate monomer such as hydroxyethylmethylacrylate (HEMA), cyclic trimethylolpropane formal acrylate (CTFA),
difunctional acrylate monomer such as tripropyleneglycoldiacrylate (TPGDA), hexanedioldiacrylate (HDDA),
trifunctional polyether acrylate monomer such as trimethylolpropane ethoxylate triacrylate (ETPTA), trimethylolpropanetriacrylate (TMPTA), and
tetrafunctional polyether acrylate monomer such as alkoxylated (4) pentaerythritol tetraacrylate (PPTTA).

Examples of non-polymerizable volatile organic solvent include but are not limited to ester solvents including acetate solvents such as n-butyl acetate and 1-methoxy-2-propanol acetate.

The polymer electrolyte generally contains an alkali metal salt complexed with the polymer matrix. There is no special requirement to the polymer forming the polymer matrix of the SPE or the base polymer of the solid polymer electrolytes. The polymer may be selected from conventional polymers in the art, including but not limited to poly vinyl ethylene carbonate-based polymers, poly carbonate-based polymers, polyethylene oxide (PEO) based polymers, modified PEO polymers, polysiloxane based polymers, poly(vinyl chloride) (PVC), poly(vinyl alcohol) (PVA), poly(acrylic acid) (PAA), polyacrylonitrile (PAN) polymers, polyvinylidene fluoride (PVDF) polymers, poly(ethyl methacrylate) (PEMA), polymethyl methacrylate (PMMA) polymers, poly(vinylidenefluoride-hexafluoro propylene) (PVdF-HFP), chitosan and the combination thereof.

The silica composition may be used as additive in the solid polymer electrolytes to improve the performance of the solid polymer electrolyte such as ionic conductivity and the performance of a lithium ion battery comprising the solid polymer electrolyte such as cycle performance.

The invention further provides a polymer electrolyte precursor composition for preparation of a solid polymer electrolyte, wherein the polymer electrolyte precursor composition comprises:
A) the silica composition of the invention; and
B) the monomer of the polymer.

The polymer electrolyte precursor composition preferably further comprises:
C) a free radical initiator for polymerization reaction of the monomer; and/or
D) a lithium salt;
and optionally
E) an organic solvent.

As used herein, the term “monomer of the polymer” refers to the monomer of the polymer forming the polymer matrix (or host polymer) of the solid polymer electrolyte. Any polymerizable solvent or polymerizable monomers that may be comprised in the silica composition are not included in the scope of term “monomer of the polymer”.

In a preferred embodiment, the polymer electrolyte precursor composition comprises:
A) the silica composition of the invention;
B) the monomer of the polymer;
C) a free radical initiator for polymerization reaction of the monomer; and
D) a lithium salt;
and optionally
E) an organic solvent.

The polymer electrolyte precursor composition of the invention comprising components A), B), C) and D) can be directly used to prepare a solid polymer electrolyte.

There is no special requirement to the amount of silica composition and the monomer of the polymer in the polymer electrolyte precursor composition as long as the silica composition can disperse uniformly in the monomer.

In some embodiments, the amount of component A) (silica composition) above is from 1 wt. % to 40 wt. %, preferably from 10 wt. % to 24 wt. %, based on the total weight of the component A) and component B) in the polymer electrolyte precursor composition.

In some embodiments, the amount of component B) (monomer of the polymer) above is from 60 wt. % to 99 wt. %, preferably from 76 wt. % to 90 wt. %, based on the total weight of the component A) and component B) in the polymer electrolyte precursor composition.

In some embodiments, when the colloidal silica dispersion comprises a polymerizable solvent, the amount of surface-modified silica particles is from 0.1 wt. % to 30 wt. %, for example 0.5 wt. % to 20 wt. %, preferably 5-12 wt. % based on the total weight of the component A) and component B) in the polymer electrolyte precursor composition.

In some embodiments, when the silica composition is an evaporated product of a surface-modified colloidal silica dispersion comprising a non-polymerizable volatile organic solvent, the amount of surface-modified silica particles is from 0.1 wt. % to 30 wt. %, for example 0.5 wt. % to 20 wt. %, 1.5 wt. % to 15 wt. %, preferably 3-10 wt. % based on the total weight of the component A) and component B) in the polymer electrolyte precursor composition.

The invention provides use of the polymer electrolyte precursor composition of the invention in preparation of a solid polymer electrolyte, especially to improve the performance of the solid polymer electrolyte such as ionic conductivity and the performance of a lithium ion battery comprising the solid polymer electrolyte such as cycle performance.

The invention further provides a method to improve the performance of a lithium-ion battery comprising a solid polymer electrolyte, such as cycle performance, wherein the preparation of solid polymer electrolyte comprises applying the use of the silica composition or the polymer electrolyte precursor composition or the use of the polymer electrolyte precursor composition of the invention in preparation of the solid polymer electrolyte.

As used herein, the term “applying the use of” refers to “using”.

The invention further provides a method to prepare a solid polymer electrolyte, comprising the step of applying the use of the silica composition of the invention or the polymer electrolyte precursor composition of the invention or the use of the polymer electrolyte precursor composition in preparation of the solid polymer electrolyte.

In some embodiments, the method comprises the step of:
mixing the silica composition of the invention with the monomer of the polymer.

The present invention further provides a method to in-situ prepare a solid polymer electrolyte, comprising the steps as follows,
1) injecting the polymer electrolyte precursor composition of the invention comprising components A), B), C) and D) into a battery case, followed by sealing; and
2) polymerizing in-situ the polymer electrolyte precursor composition e.g. by heating.

Such method can improve the performance of a lithium-ion battery comprising a solid polymer electrolyte, such as cycle performance.

When the silica composition comprises:
a polymerizable solvent, which is selected from monomers, oligomers and/or prepolymers convertible to polymers by nonradical or radical reactions,
the polymerization reaction may also happen between the polymerizable solvent of the silica composition and component B) (the monomer of the polymer) of the polymer electrolyte precursor composition.

The invention further provides a solid polymer electrolyte, comprising silica particles, wherein the average particle size of the silica, especially as measured by means of small-angle neutron scattering (SANS), is between 3 and 50 nm, preferably 5-40 nm, more preferably 8-30 nm, and wherein the silica is organically surface modified, especially by silane, wherein the surface modified silica is homogeneously dispersed in the electrolyte;
or wherein the solid polymer electrolyte is prepared according to the method to prepare a solid polymer electrolyte according to the invention.

The amount of the silica is from 0.1 to 26 wt. %, preferably 2-18 wt. %, more preferably 4-18 wt. %, even more preferably 4-11 wt. % based on the total weight of the solid polymer electrolyte.

In some embodiments, the solid polymer electrolyte is prepared by crosslinking the monomer of the polymer and
the polymerizable solvent, which is selected from polymerizable monomers, oligomers and/or prepolymers convertible to polymers by nonradical reactions of the silica composition,
the solid polymer electrolyte of the invention optionally further comprises from 0.1-35 wt. %, for example 0.1-30 wt. %, or 0.1-20 wt. %, or 0.1-10 wt. % of an organic solvent based on the weight of the monomer of the polymer. Such the polymer electrolyte is surprisingly still in solid state.

There is no amount requirement on the two components monomer of the polymer and polymerizable solvent, as long as the two components can form a homogenous monomer solution.

In some embodiments, the amount of the organic solvent in the solid polymer electrolyte is up to 10, 20 or 30 wt. % based on the weight of the monomer of the polymer.

For colloidal silica dispersion with component b), the polymer electrolyte can still be in solid state comprises from up to 10 wt. % to up to 30 wt. % of organic solvent based on the weight of the monomer of the polymer.

Such quasi-solid-state crosslinked polymer electrolyte with proper amount of organic solvent reaches a good balance between ion conductivity and mechanical strength. Furthermore, the cost of the polymer electrolyte may be further reduced as the organic solvent is relatively inexpensive.

The present invention further provides an electrochemical device comprising the solid polymer electrolyte according to the present invention.

In some examples, the electrochemical device is a secondary battery, e.g. a lithium-ion battery, especially a lithium metal secondary battery.

The electrochemical device encompasses all kinds of devices that undergo electrochemical reactions. Examples of the electrochemical device include all kinds of primary batteries, secondary batteries, fuel cells, solar cells, capacitors and the like, preferably secondary batteries.

The invention further provides a device, comprising the electrochemical device according to the invention. The device includes but not limited to, electric vehicles, electric home appliances, electric tools, portable communication devices such as mobile phones, consumer electronic products, and any other products that are suitable to incorporate the electrochemical device or lithium ion battery of the invention as an energy source.

Examples of the silica composition of the invention include:
Nanocryl® A 223, which is a versatile dispersion of colloidal silica in a trifunctional polyether acrylate typically for the use in adhesive applications. The silica phase consists of surface-modified, synthetic SiO₂-spheres of very small size (Ø 20 nm) and narrow particle size distribution. Despite the high SiO₂-content of 50 wt. %, Nanocryl® A 223 is highly transparent, low viscous and shows no sedimentation due to the agglomerate-free dispersion of the nanoparticles in the acrylate. The trifunctional polyether acrylate above is trimethylolpropane ethoxylate triacrylate (ETPTA, average Mn˜428).
Nanocryl® A 235, which is a versatile dispersion of colloidal silica in a tetrafunctional polyether acrylate typically for the use in adhesive and electronic applications. The silica phase consists of surface-modified, synthetic SiO₂-spheres of very small size (Ø 20 nm) and narrow particle size distribution. Despite the high SiO₂-content of 50 wt. %, NANOCRYL® A 235 is highly transparent, low viscous and shows no sedimentation due to the agglomerate-free dispersion of the nanoparticles in the acrylate. The tetrafunctional polyether acrylate above is alkoxylated (4) pentaerythritol tetraacrylate (PPTTA, average Mn˜528).
NANOCRYL® A 200, which is a versatile dispersion of colloidal silica in a monofunctional acrylate monomer for the use in adhesive applications. The monofunctional acrylate monomer is cyclic trimethylolpropane formal acrylate (CTFA, CAS No: 66492-51-1).
NANOCRYL® A 210, which is a versatile dispersion of colloidal silica in a difunctional acrylate monomer for the use in adhesive and electronic applications. The dispersion comprises high SiO₂ content of 50 wt. %. The difunctional acrylate monomer is hexanedioldiacrylate (HDDA).
NANOCRYL® A 215, which is a versatile dispersion of colloidal silica in a difunctional acrylate monomer for the use in adhesive applications. The dispersion comprises high SiO₂ content of 50 wt. %. The difunctional acrylate monomer is tripropyleneglycoldiacrylate (TPGDA).
NANOCRYL® A 220, which is a versatile dispersion of colloidal silica in a trifunctional acrylate monomer for the use in adhesive applications. The dispersion comprises high SiO₂ content of 50 wt. %. The trifunctional acrylate monomer is trimethylolpropanetriacrylate (TMPTA).
NANOCRYL® A 370, which is a versatile dispersion of colloidal silica in a monofunctional acrylate monomer. The dispersion comprises high SiO₂ content of 50 wt. %. The monofunctional acrylate monomer is hydroxyethylmethylacrylate (HEMA).
Evaporated Nanopol® A 720 without solvent. Nanopol® A 720 is a versatile dispersion of colloidal silica in n-butyl acetate solvent. The silica phase consists of surface-modified, synthetic SiO₂-spheres of very small size (Ø 20 nm) and narrow particle size distribution. Despite the high SiO₂-content of 50 wt. %, Nanopol® A 720 is highly transparent, low viscous and shows no sedimentation due to the agglomerate-free dispersion of the nanoparticles in the solvent. In the invention, the solvent n-butyl acetate of Nanopol® A 720 is evaporated (e.g. by heating at 80° C. under vacuum for 48 h) and the solid evaporated Nanopol® A 720 without solvent is used as the silica composition of the invention, as organic solvent is undesirable in the solid polymer electrolyte of the invention.
Evaporated Nanopol® A 710 without solvent. Nanopol® A 710 is a versatile dispersion of colloidal silica in 1-methoxy-2-propanol acetate solvent. The dispersion comprises high SiO₂ content of 50 wt. %.

The above Nanocryl® and Nanopol® series products are all commercially available from Evonik Industries AG.

### Monomer of the Polymer

The monomers useable to prepare the polymer (i.e. polymer matrix) of the solid polymer electrolyte of the invention include but not are limited to those conventional in the art. For example, vinyl ethylene carbonates (VEC), or ethylene oxide (EO).

### Free Radical Initiator

The free radical initiator of the polymerization reaction is for the polymerization (e.g. thermal polymerization) reaction of the reactive monomers, and may be those conventional in the art.

Examples of free radical initiator or the polymerization initiator may include azo compounds such as 2,2-azobis(2-cyanobutane), 2,2-azobis(methylbutyronitrile), 2,2′-azoisobutyronitrile (AIBN), azobisdimethyl-valeronitrile (AMVN) and the like, peroxy compounds such as benzoyl peroxide, acetyl peroxide, dilauryl peroxide, di-tert-butyl peroxide, cumyl peroxide, hydrogen peroxide and the like, and hydroperoxides. Preferably, AIBN, 2,2′-azobis(2,4-dimethyl valeronitrile) (V65), Di-(4-tert-butylcyclohexyl)-peroxydicarbonate (DBC), or the like may also be employed.

Preferably the free radical initiator may be selected from azobisisobutyronitrile (AIBN), azobisisoheptanenitrile (ABVN), benzoyl peroxide (BPO), lauroyl peroxide (LPO) and so on. More preferably, the free radical initiator is benzoyl peroxide.

The amount of the free radical initiator is conventional. Preferably the amount of the free radical initiator is 0.1-3 wt. %, more preferably around 0.5 wt. % based on the total weight of the polymerizable components in the polymer electrolyte precursor composition. The polymerizable components include components with C═C bonds, such as
component B) the monomer of the polymer, and
the any polymerizable components that may present in component A) the silica composition of the invention, such as polymerizable solvent, which is selected from monomers, oligomers and/or prepolymers convertible to polymers by nonradical or radical reactions.

In some embodiments, the polymerization initiator is decomposed at a certain temperature of 40 to 80° C. to form radicals, and may react with monomers via the free radical polymerization to form a polymer electrolyte. Generally, the free radical polymerization is carried out by sequential reactions consisting of the initiation involving formation of transient molecules having high reactivity or active sites, the propagation involving re-formation of active sites at the ends of chains by addition of monomers to active chain ends, the chain transfer involving transfer of the active sites to other molecules, and the termination involving destruction of active chain centers.

### Lithium Salt

The lithium salt is a material that is dissolved in the non-aqueous electrolyte to thereby resulting in dissociation of lithium ions from the anions.

The lithium salt may be those used conventional in the art but is thermally stable during in-situ polymerization (e.g. at 80° C.), non-limiting examples may be at least one lithium selected from bis imide (LiFSI), (fluorosulfonyl) lithium bis(trifluoromethanesulfonyl)imide (LiTFSI), lithium difluorooxalate borate (LiODFB), lithium bis(oxalato) borate (LiBOB) LiAsF₆, LiClO₄, LiN(CF₃SO₂)₂, LiBF₄, LiSbF₆, and LiCl, LiBr, LiI, LiB₁₀Cl₁₀, LiCF₃SO₃, LiCF₃CO₂, LiAlCl₄, CH₃SO₃Li, CF₃SO₃Li, (CF₃SO₂)₂NLi, chloroborane lithium, lower aliphatic carboxylic acid lithium, lithium tetraphenyl borate and imide. The lithium salt is preferably selected from LiFSI, LiTFSI and LiODFB. These materials may be used alone or in any combination thereof.

The amount of lithium salt is also conventional, for example 5-40 wt. %, most preferably around 15 wt. % based on the total weight of the polymer electrolyte precursor composition.

### Organic Solvent

The organic solvent may be conventional in the art. For example, the organic solvent may be aprotic organic solvents such as N-methyl-2-pyrrolidinone (NMP), propylene carbonate (PC), ethylene carbonate (EC), butylene carbonate (BC), dimethyl carbonate (DMC), diethyl carbonate (DEC), ethylmethyl carbonate (EMC), gamma-butyrolactone, dimethylsulfoxide, methyl formate, methyl acetate, phosphoric acid triester, sulfolane, methyl sulfolane, 1,3-dimethyl-2-imidazolidinone, propylene carbonate derivatives, methyl propionate and ethyl propionate. These materials may be used alone or in any combination thereof.

The organic solvent is preferably a carbonate solvent. The carbonate solvent may preferably be selected from the group consisting of ethylene carbonate/dimethyl carbonate (EC/DMC), ethylene carbonate (EC), propylene carbonate (PC), dimethyl carbonate (DMC), ethyl methyl carbonate (EMC), diethyl carbonate (DEC) and gamma-butyrolactone (GBL). In some examples, the organic solvent is preferably ethylene carbonate/dimethyl carbonate (EC/DMC, EC/DMC=50/50 (v/v)).

The amount of the organic solvent is conventional so long as the polymer electrolyte is in solid state.

Additionally, in order to improve charge/discharge characteristics and flame retardancy, for example, pyridine, triethylphosphite, triethanolamine, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride or the like may be added to the electrolyte. If necessary, in order to impart incombustibility, the electrolyte may further include halogen-containing solvents such as carbon tetrachloride and ethylene trifluoride.

The solid polymer electrolyte of the invention exhibited improved performance such as ion conductivity, electrochemical window, and lithium ion transference number, and an electrochemical device such as lithium ion battery comprising the polymer electrolyte of the invention has improved performance such as cycle performance including capacity retention than that of the prior art which does not use the silica composition of the invention. Furthermore, the surface-modified colloidal silica nanoparticles of the silica composition of the invention show excellent dispersion in solid polymer electrolytes. The solid polymer electrolyte of the invention exhibits good polymer-filler interaction and better the mechanical properties. The agglomeration of ceramic fillers of prior art was also eliminated or reduced in the invention.

Other advantages of the present invention would be apparent for a person skilled in the art upon reading the specification.

### BRIEF DESCRIPTION OF DRAWINGS

FIG. 1 shows the ionic conductivity of the solid polymer electrolyte prepared in Comparative Example 1.

FIG. 2 shows the electrochemical stability window test result of the solid polymer electrolyte prepared in Comparative Example 1.

In FIG. 3, FIG. 3a shows the chronoamperometry profile under polarization of the solid polymer electrolyte prepared in Comparative Example 1. FIG. 3b shows the corresponding AC impedance spectra for the initial state before polarization and stable state after polarization of the solid polymer electrolyte prepared in Comparative Example 1.

In FIG. 4, FIG. 4a shows the cycle performance of a Li/LFP cell with the solid polymer electrolyte prepared in Comparative Example 1 at 0.2 C rate. FIG. 4b shows the cycle performance of a Li/NCM523 cell with the solid polymer electrolyte prepared in Comparative Example 1 at 0.2 C rate.

FIG. 5 shows the ionic conductivity of the solid polymer electrolytes prepared in Example 2-1 (FIG. 5a), Example 2-2 (FIG. 5b) and Example 2-3 (FIG. 5c).

FIG. 6 shows the electrochemical stability window test results of the solid polymer electrolytes prepared in Example 2-1 (FIG. 6a), Example 2-2 (FIG. 6b) and Example 2-3 (FIG. 6c).

FIG. 7 shows the cycle performance of the solid polymer electrolytes prepared in Example 2-1, Example 2-2 and Example 2-3 at 0.2 C rate. FIG. 7a shows the cycle performance of a Li/LFP cell with the solid polymer electrolyte prepared in Example 2-2 at 0.2 C rate. FIG. 7b shows the cycle performance of a Li/NCM523 cell with the solid polymer electrolyte prepared in Example 2-1 at 0.2 C rate. FIG. 7c shows the cycle performance of a Li/NCM523 cell with the solid polymer electrolyte prepared in Example 2-2 at 0.2 C rate. FIG. 7d shows the cycle performance of a Li/NCM523 cell with the solid polymer electrolyte prepared in Example 2-3 at 0.2 C rate.

FIG. 8 shows the ionic conductivity of the quasi-solid-state polymer electrolytes prepared in Example 2-2-1, Example 2-2-2 and Example 2-2-3.

FIG. 9 shows the electrochemical stability window test results of the quasi-solid-state polymer electrolytes prepared in Example 2-2-1, Example 2-2-2 and Example 2-2-3.

FIG. 10 shows the digital photos of the quasi-solid-state polymer electrolytes prepared in the bottles in Example 2-2-1, Example 2-2-2 and Example 2-2-3.

FIG. 11 shows the ionic conductivity of the solid polymer electrolytes prepared in Example 3-1 (FIG. 11a), Example 3-2 (FIG. 11b) and Example 3-3 (FIG. 11c).

FIG. 12 shows the electrochemical stability window test results of the solid polymer electrolytes prepared in Example 3-1 (FIG. 12a), Example 3-2 (FIG. 12b) and Example 3-3 (FIG. 12c).

FIG. 13 shows a comparison graph of the ionic conductivity of the solid polymer electrolytes prepared in Example 4-1, Example 4-2 and Comparative Example 4-3.

FIG. 14 shows a comparison graph of the electrochemical stability window test result of the solid polymer electrolytes prepared in Example 4-1, Example 4-2 and Comparative Example 4-3.

In FIG. 15, FIG. 15a shows the chronoamperometry profile under polarization of the solid polymer electrolyte prepared in Example 4-1. FIG. 15b shows the corresponding AC impedance spectra for the initial state before polarization and stable state after polarization of the solid polymer electrolyte prepared in Example 4-1.

In FIG. 16, FIG. 16a shows the chronoamperometry profile under polarization of the solid polymer electrolyte prepared in Example 4-2. FIG. 16b shows the corresponding AC impedance spectra for the initial state before polarization and stable state after polarization of the solid polymer electrolyte prepared in Example 4-2.

In FIG. 17, FIG. 17a shows the chronoamperometry profile under polarization of the solid polymer electrolyte prepared in Comparative Example 4-3. FIG. 17b shows the corresponding AC impedance spectra for the initial state before polarization and stable state after polarization of the solid polymer electrolyte prepared in Comparative Example 4-3.

In FIG. 18, FIG. 18a, FIG. 18b and FIG. 18c show the cycle performance of Li/NCM523 cells with the solid polymer electrolytes prepared in Example 4-1. Example 4-2 and Comparative Example 4-3 at 0.2 C rate, respectively.

FIG. 19 shows the ionic conductivity of the solid polymer electrolytes prepared in Example 5-1, Example 5-2 and Example 5-3.

FIG. 20 shows the electrochemical stability window test results of the solid polymer electrolytes prepared in Example 5-1, Example 5-2 and Example 5-3.

FIG. 21 shows the ionic conductivity of the solid polymer electrolytes prepared in Comparative Example 6-1, Comparative Example 6-2 and Example 6-3.

FIG. 22 shows the electrochemical stability window test result of the solid polymer electrolytes prepared in Comparative Example 6-1, Comparative Example 6-2, Example 6-3.

In FIG. 23, FIG. 23a, FIG. 23b, FIG. 23c, FIG. 23d show the surficial scanning electron microscope (SEM) images of solid polymer electrolytes prepared in Comparative Example 1, Example 2-2, Example 3 and Comparative Example 4-3, respectively.

FIG. 23e, FIG. 23f, FIG. 23g, FIG. 23h show the cross-sectional SEM images of solid polymer electrolytes prepared in Comparative Example 1, Example 2-2, Example 3 and Comparative Example 4-3, respectively.

### DETAILED DESCRIPTION OF THE INVENTION

The invention is now described in detail by the following examples. The scope of the invention should not be limited to the embodiments of the examples.

Unless specified otherwise, all of the tests were performed at room temperature.

### Comparative Example 1: Poly Vinyl Ethylene Carbonate (PVEC)-Based Electrolyte

The schematic general formula of PVEC and preparation process thereof is as follows in Scheme 1.

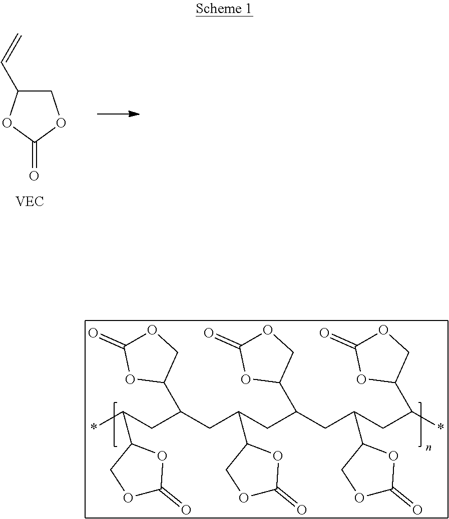

### Preparation of Precursor Electrolyte Dispersion:

1 g vinyl ethylene carbonate (VEC), 0.157 g lithium bis (fluorosulfonyl) imide (LiFSI) and 0.005 g benzoyl peroxide (BPO) were mixed and stirred at 25° C. for 0.5 h to obtain a precursor electrolyte dispersion.

### Cell Assembly and In-Situ Polymerization by Heating:

A LiNi_{0.5}Co_{0.2}Mn_{0.3}O₂ (NCM523) cathode was prepared as follows. NCM523, acetylene black, and poly(vinylidene difluoride) in the weight ratio of 80:10:10 were mixed to form a viscous slurry. Then, a flat aluminum foil was coated with the viscous slurry by the doctor blade process. The aluminum foil coated with the viscous slurry was dried at 80° C. for 1 hour in an air-circulating oven and further dried at 120° C. under high vacuum for 12 h to obtain a LiNi_{0.5}Co_{0.2}Mn_{0.3}O₂ cathode. The mass loading of active material (LiNi_{0.5}Co_{0.2}Mn_{0.3}O₂) was 2-4 mg cm⁻². The precursor electrolyte dispersion was injected into a CR2032 lithium battery with a cellulose separator which separated cathode and anode (Li foil), then the cells were heated at 80° C. for 24 h.

A LiFePO₄ (LFP) cathode was prepared the same way as LiNi_{0.5}Co_{0.2}Mn_{0.3}O₂ (NCM523) cathode above except that LiFePO₄ was used to replace NCM523.

After the heating process (i.e., at 80° C. for 24 h above), solid polymer electrolyte without flowable liquid phase between the anode and cathode could be obtained.

The solid state of the polymer electrolyte was confirmed as the CR2032 battery was disassembled.

### PVEC-Nanocryl® A 223 Nanoparticles Hybrid Electrolytes

In the following Examples 2-1, 2-2 and 2-3, PVEC-Nanocryl® A 223 nanoparticles hybrid electrolytes were prepared.

The schematic general formula of PVEC/nanoparticles and preparation process thereof is as follows in Scheme 2.

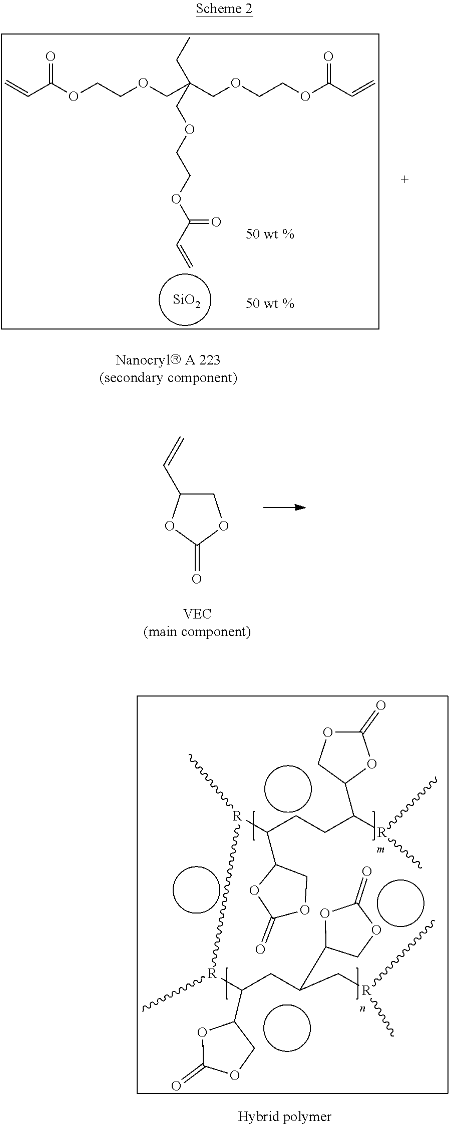

### Example 2-1

### 1) Preparation of Precursor Electrolyte Dispersion:

0.9 g VEC, 0.1 g Nanocryl® A 223 (50 wt. % colloidal silica and 50 wt. % ETPTA), 0.157 g LiFSI and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

### Example 2-2

### 1) Preparation of Precursor Electrolyte Dispersion:

0.8 g VEC, 0.2 g Nanocryl® A 223 (50 wt. % colloidal silica and 50 wt. % ETPTA), 0.157 g LiFSI and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

### Example 2-3

### 1) Preparation of Precursor Electrolyte Dispersion:

0.7 g VEC. 0.3 g Nanocryl® A 223 (50 wt. % colloidal silica and 50 wt. % ETPTA), 0.157 g LiTFSI and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

PVEC-Nanocryl® A 223 Nanoparticles Hybrid Electrolytes with Solvent

In the following Examples 2-2-1, 2-2-2, and 2-2-3, organic solvent is further added to prepare a precursor electrolyte dispersion compared with preparation of precursor electrolyte dispersion in Example 2-2.

### Example 2-2-1

### 1) Preparation of Precursor Electrolyte Dispersion:

0.9 g VEC, 0.1 g Nanocryl® A 223 (50 wt. % colloidal silica and 50 wt. % ETPTA), 0.157 g LiFSI, 0.1 g EC/DMC (1:1) and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, quasi-solid-state polymer electrolyte without flowable liquid phase between the anode and cathode could be obtained. The solid state of the polymer electrolyte was confirmed as the CR2032 battery was disassembled.

### Example 2-2-2

### 1) Preparation of Precursor Electrolyte Dispersion:

0.8 g VEC, 0.2 g Nanocryl® A 223 (50 wt. % colloidal silica and 50 wt. % ETPTA). 0.157 g LiFSI, 0.2 g EC/DMC (1:1) and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, quasi-solid-state polymer electrolyte without flowable liquid phase between the anode and cathode could be obtained. The solid state of the polymer electrolyte was confirmed as the CR2032 battery was disassembled.

### Example 2-2-3

### 1) Preparation of Precursor Electrolyte Dispersion:

0.7 g VEC, 0.3 g Nanocryl® A 223 (50 wt. % colloidal silica and 50 wt. % ETPTA), 0.157 g LiTFSI, 0.3 g EC/DMC (1:1) and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, quasi-solid-state polymer electrolyte without flowable liquid phase between the anode and cathode could be obtained. The solid state of the polymer electrolyte was confirmed as the CR2032 battery was disassembled.

The homogeneous precursor electrolyte dispersions of Examples 2-2-1, 2-2-2, and 2-2-3 were added into three empty bottles in a same amount (3 g) respectively and were polymerized by heating at 80° C. for 24 h in an Ar atmosphere. After the polymerization was complete, the bottles were inversed and taken photos. As shown in FIG. 10, the polymer electrolytes were all in quasi-solid state.

As shown in FIG. 8 and FIG. 9, after the addition of organic solvent, the ionic conductivity increased and electrochemical window narrowed with the increasing of the concentration of organic solvent (10 wt. %, 20 wt. % and 30 wt. %). This proves that crosslinked structure of PVEC and Nanocryl® A 223 can store organic solvent well and can still be in a solid state even the electrolyte comprises up to 30 wt. % of organic solvent.

### PVEC-Evaporated Nanopol® A 720 Nanoparticles Hybrid Electrolytes

In the following Examples 3-1, 3-2 and 3-3, PVEC-evaporated Nanopol® A 720 nanoparticles hybrid electrolytes were prepared.

The schematic general formula of PVEC/nanoparticles and preparation process thereof is as follows in Scheme 3.

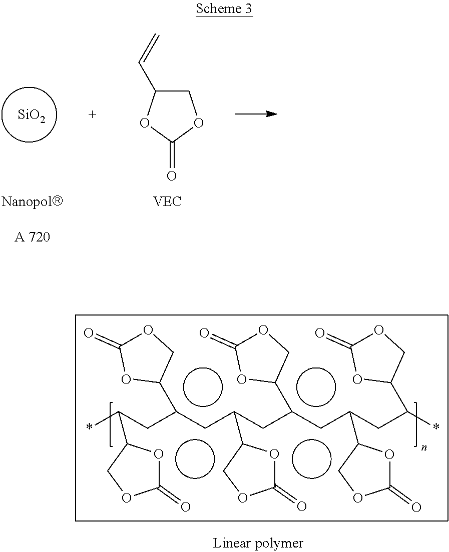

### Example 3-1

### 1) Preparation of Precursor Electrolyte Dispersion:

0.95 g VEC, 0.05 g evaporated Nanopol® A 720 (solid silica after removing the solvent at 80° C. under vacuum for 48 h), 0.157 g LiFSI and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

### Example 3-2

1) Preparation of precursor electrolyte homogeneous dispersion:

0.90 g VEC, 0.1 g evaporated Nanopol® A 720 (solid silica after removing the solvent at 80° C. under vacuum for 48 h), 0.157 g LiFSI and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

### Example 3-3

### 1) Preparation of Precursor Electrolyte Dispersion:

0.85 g VEC, 0.15 g evaporated Nanopol® A 720 (solid silica after removing the solvent at 80° C. under vacuum for 48 h), 0.157 g LiFSI and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

Comparison of Electrolytes Prepared with Different Fillers

In the following Examples 4-1, 4-2 and Comparative Example 4-3, the performance of Nanocryl® A 223, evaporated Nanopol® A 720 and fumed silica in preparation of polymer electrolytes (each with 7 wt. % silica) were compared by ionic conductivity, electrochemical windows and cycle performance with NCM523 cathode.

### Example 4-1

### 1) Preparation of Precursor Electrolyte Dispersion:

0.86 g VEC, 0.14 g Nanocryl® A 223 (with 50 wt. % colloidal silica and 50 wt. % ETPTA), 0.157 g LiFSI and 0.005 g BPO were mixed and stirred at 25° C. for 0.5 h to obtain a homogeneous precursor electrolyte homogeneous dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

### Example 4-2

### 1) Preparation of Precursor Electrolyte Dispersion:

0.93 g VEC, 0.07 g evaporated Nanopol® A 720 (solid silica after removing the solvent at 80° C. under vacuum for 48 h), 0.157 g LiFSI and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

As shown in FIG. 13, the ionic conductivity of the electrolytes prepared in Example 4-1 and Example 4-2 were 1.72×10⁻⁴ S cm⁻¹ and 1.15×10⁻⁴ S cm⁻¹ respectively and were both higher than that of the electrolyte prepared in Comparative Example 4-3, which was 0.92×10⁻⁴ S cm⁻¹.

As shown in FIG. 14, the electrochemical window of the electrolytes prepared in Example 4-1 and Example 4-2 was 5.1 V and was higher than that of the electrolyte prepared in Comparative Example 4-3, which was 5.0 V.

The Li/NCM523 cells using electrolytes prepared in Example 4-1 and Example 4-2 showed high capacity retentions after 200 cycles, which were 78.13% and 70.82% respectively. On the other hand, the Li/NCM523 cell using electrolyte prepared in Comparative Example 4-3 died when reached 110^{th} cycle.

The fumed silica used in the Comparative Examples 4-3, 4-4 and 4-5 was hydrophobic “Nano fumed silica” (Product No.: N817573, Cas No.: 60676-86-0, 99.8% metals basis, 7-40 nm particle size, 230 m²/g specific surface area (BET), commercially available from Shanghai Macklin Biochemical Co., Ltd., China).

### Comparative Example 4-3

### 1) Preparation of Precursor Electrolyte Dispersion:

0.93 g VEC, 0.07 g fumed silica (Cas No.: 60676-86-0), 0.157 g LiFSI and 0.005 g BPO were mixed and stirred at 25° C. for 0.5 h to obtain a precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid polymer electrolyte was confirmed as the CR2032 battery was disassembled.

### Comparative Example 4-4

0.90 g VEC, 0.10 g fumed silica (Cas No.: 60676-86-0), 0.157 g LiFSI and 0.005 g BPO were mixed and stirred at 25° C. for 0.5 h. The fumed silica could not be dissolved or dispersed completely and a homogeneous precursor electrolyte dispersion could not be obtained.

### Comparative Example 4-5

0.85 g VEC, 0.15 g fumed silica (Cas No.: 60676-86-0), 0.157 g LiFSI and 0.005 g BPO were mixed and stirred at 25° C. for 0.5 h. The fumed silica could not be dissolved or dispersed completely and a homogeneous precursor electrolyte dispersion could not be obtained.

Performance test like ionic conductivity and electrochemical window could not be measured for Comparative Example 4-4 and Comparative Example 4-5, as a homogeneous precursor electrolyte dispersion could not be obtained in these comparative examples.

### PVEC-Nanocryl® A 235 Nanoparticles Hybrid Electrolytes

In the following Examples 5-1, 5-2 and 5-3, PVEC-Nanocryl® A 235 nanoparticles hybrid electrolytes were prepared with different amounts of colloidal silica.

The schematic general formula of the PVEC/Nanocryl® A 235 nanoparticles and preparation process thereof is as follows in Scheme 4.

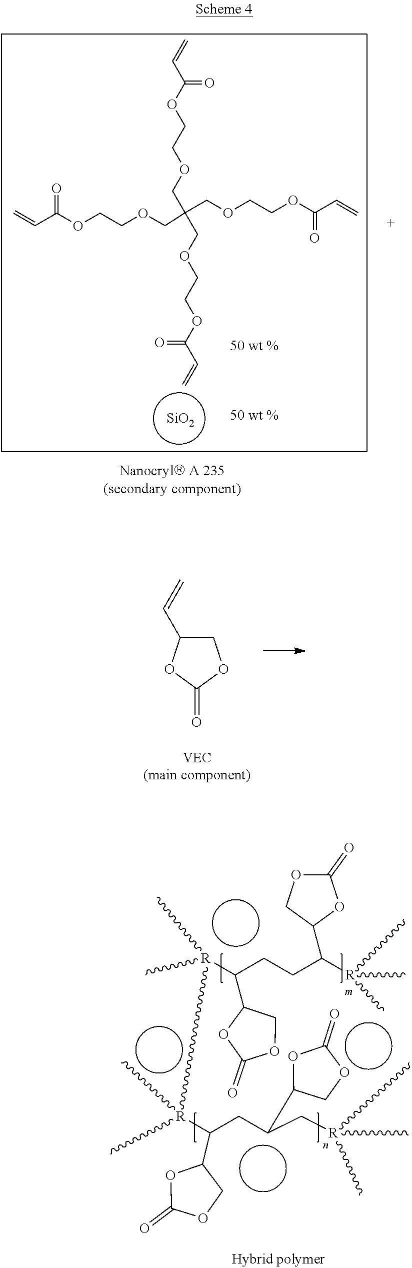

### Example 5-1

### 1) Preparation of Precursor Electrolyte Dispersion:

0.9 g VEC, 0.1 g Nanocryl® A 235 (50 wt. % colloidal silica and 50 wt. % PPTTA), 0.157 g LiFSI and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

### Example 5-2

### 1) Preparation of Precursor Electrolyte Dispersion:

0.8 g VEC, 0.2 g Nanocryl® A 235 (50 wt. % colloidal silica and 50 wt. % PPTTA), 0.157 g LiFSI and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

### Example 5-3

### 1) Preparation of Precursor Electrolyte Dispersion:

0.7 g VEC, 0.3 g Nanocryl® A 235 (50 wt. % colloidal silica and 50 wt. % PPTTA), 0.157 g LiTFSI and 0.005 g BPO were mixed and stirred at 25° C. for 0.5 h to obtain a homogeneous precursor electrolyte dispersion.

2) Cell assembly and in-situ polymerization by heating was conducted according to the same method as Comparative Example 1.

After the heating process, solid polymer electrolyte without flowable liquid phase between the anode and cathode could be obtained. The solid state of the polymer electrolyte was confirmed as the CR2032 battery was disassembled.

### Performance Test of the Polymer Electrolyte

### 1. Electrochemical Window

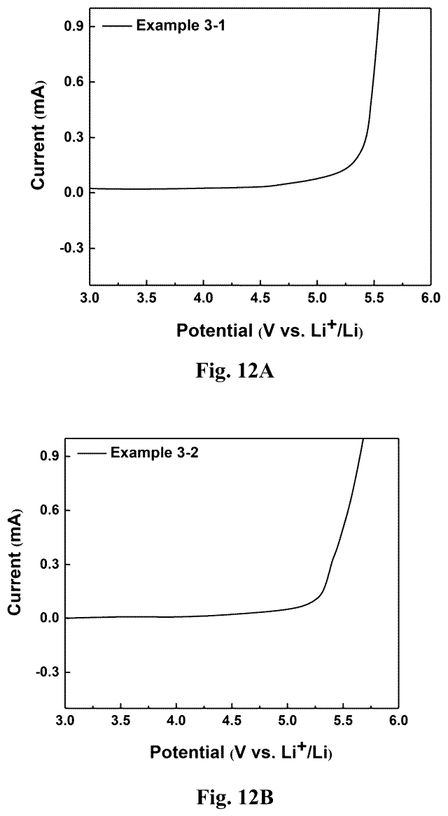

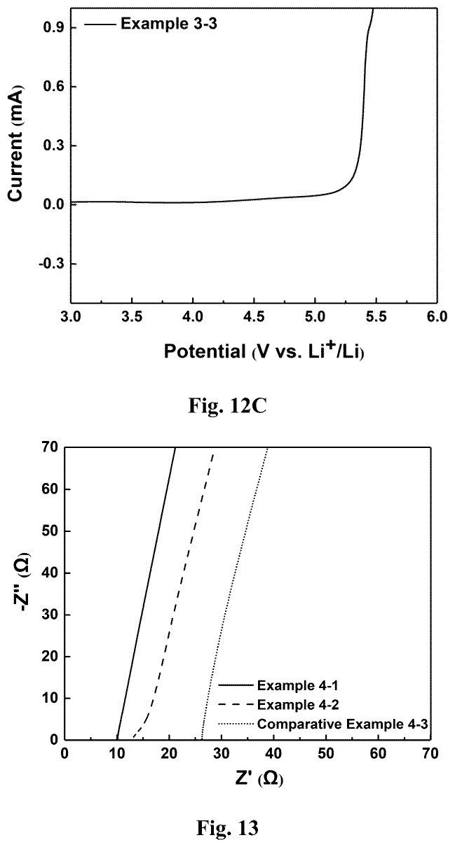

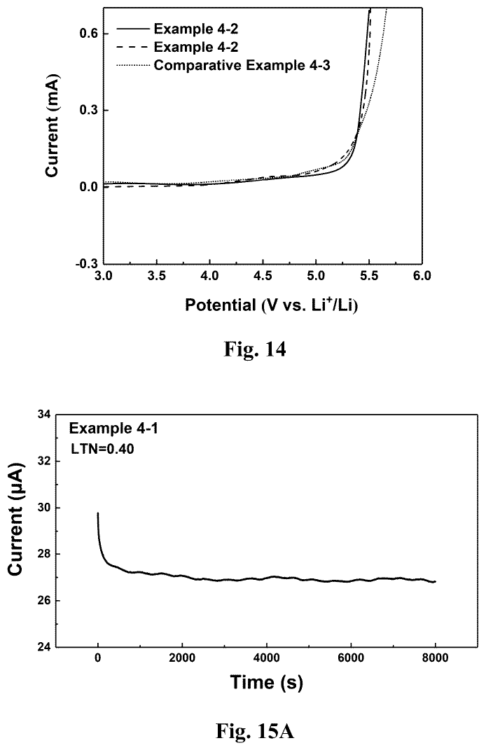

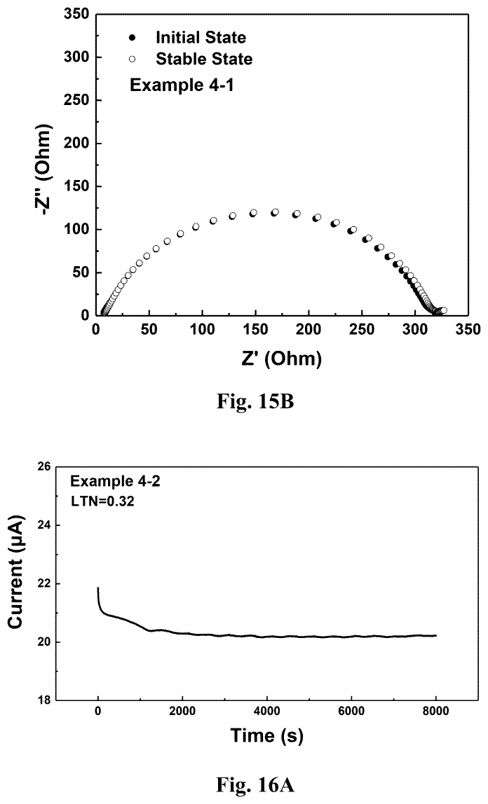

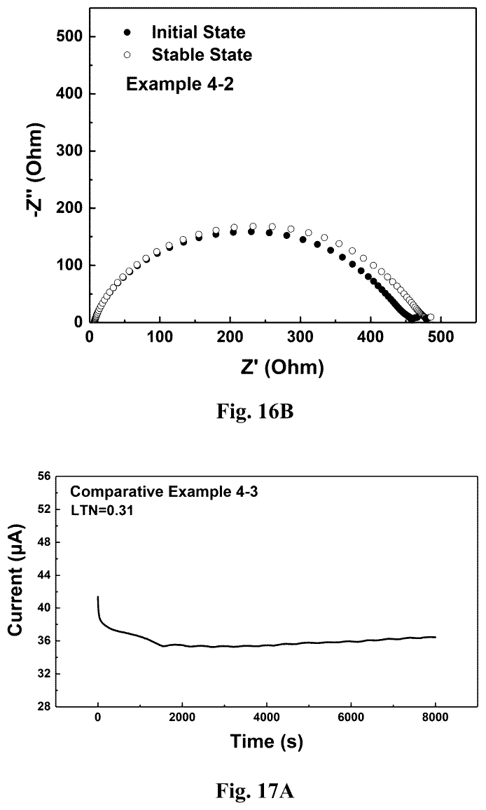

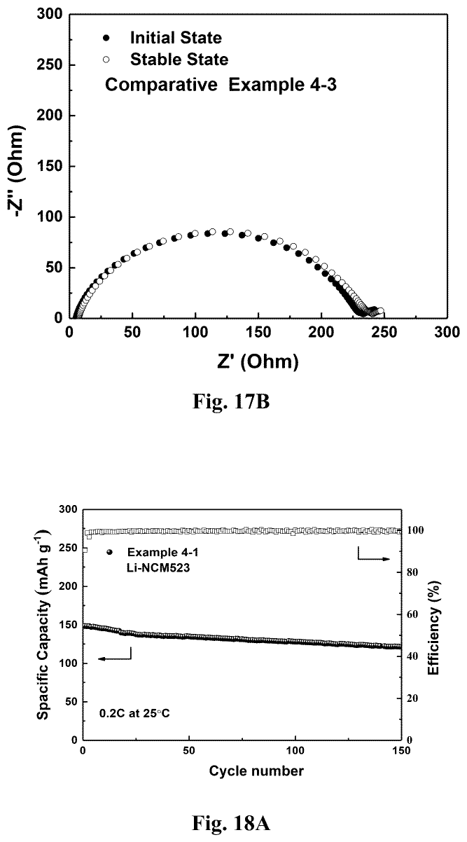

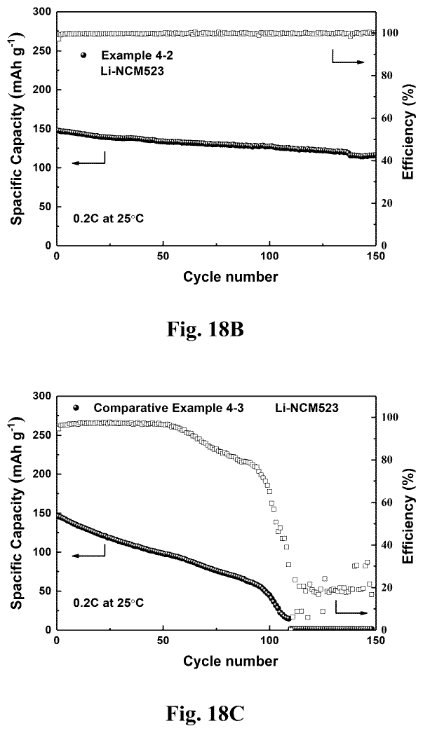

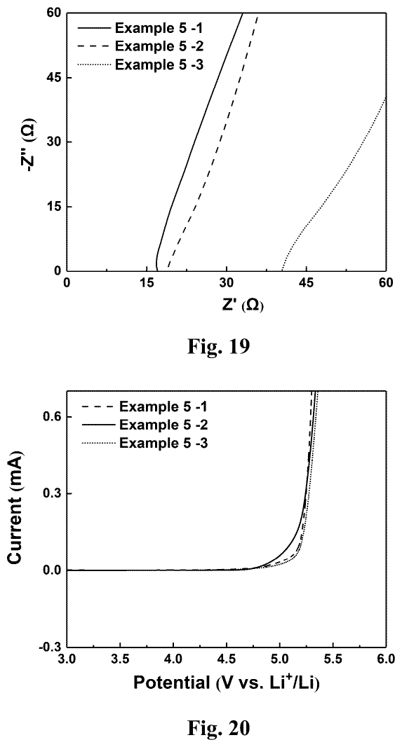

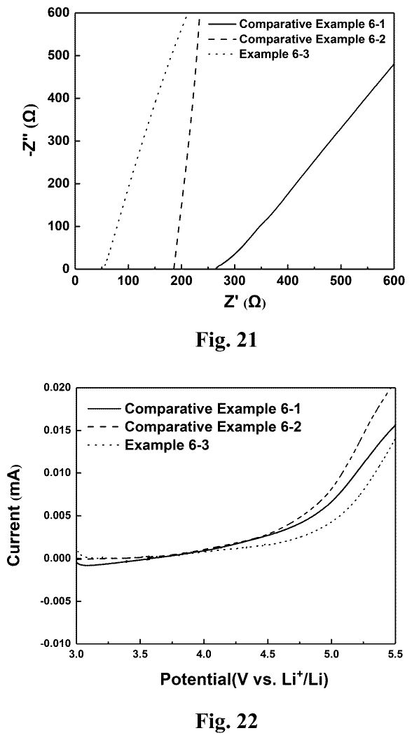

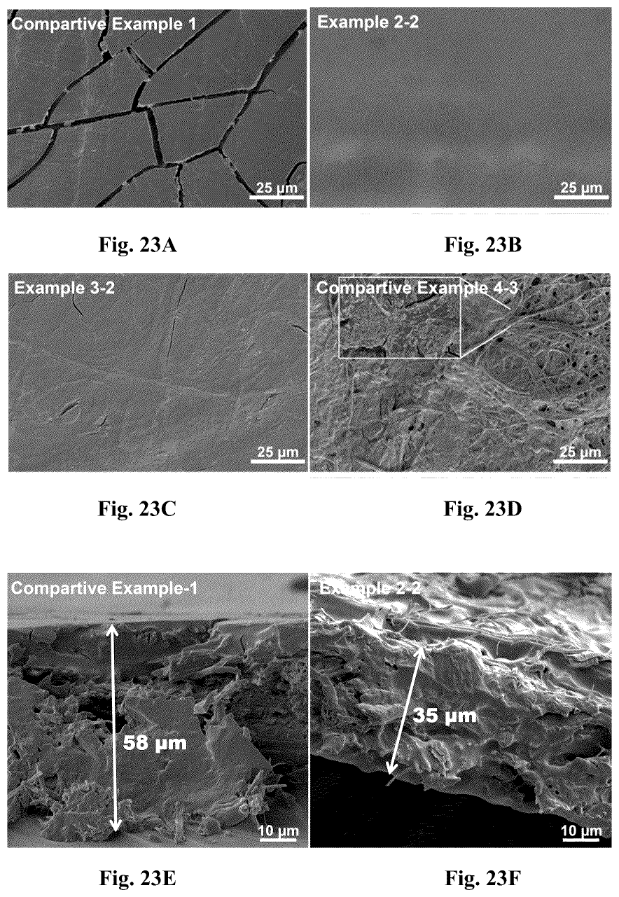

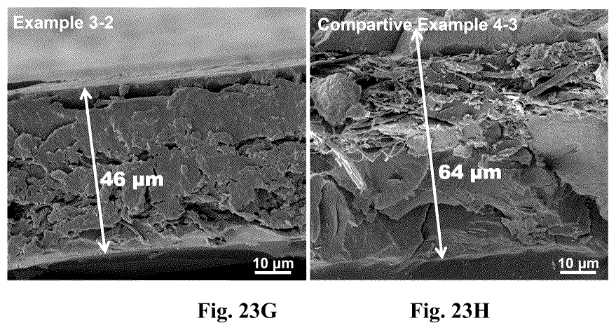

The electrochemical stability of polymer electrolyte of the invention was evaluated by linear sweep voltammetry (LSV) performed with SS (stainless steel)/polymer electrolyte/Li CR2032 coin cell at a scan rate of 10 mV S⁻¹ from open circuit voltage of each cell to 6 V vs. Li⁺/Li at room temperature in a CHI650e electrochemical workstation (Shanghai Chenhua Instruments Co., Ltd., China). The results obtained by the test are shown in FIG. 2, FIG. 6, FIG. 9, FIG. 12, FIG. 14, FIG. 20 and FIG. 22.

As shown in FIG. 2, the electrochemical window of the electrolyte prepared in Comparative Example 1 is 4.8 V. The polymer electrolyte according to the present invention showed a more stable and higher electrochemical stability window, e.g. 5.1 V in Example 2 and 5.0 V in Example 3, which could contribute to better electrochemical performance. A stable electrochemical stability window close to or above 5.0 V is very important, which makes it possible to employ novel layered LiNiₓCo_{y}Mn_{z}O₂ cathodes in lithium-ion batteries.

### 2. Ionic Conductivity

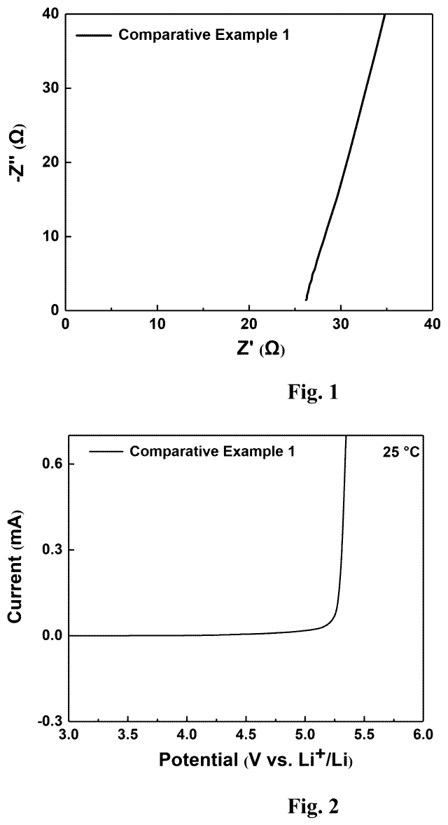

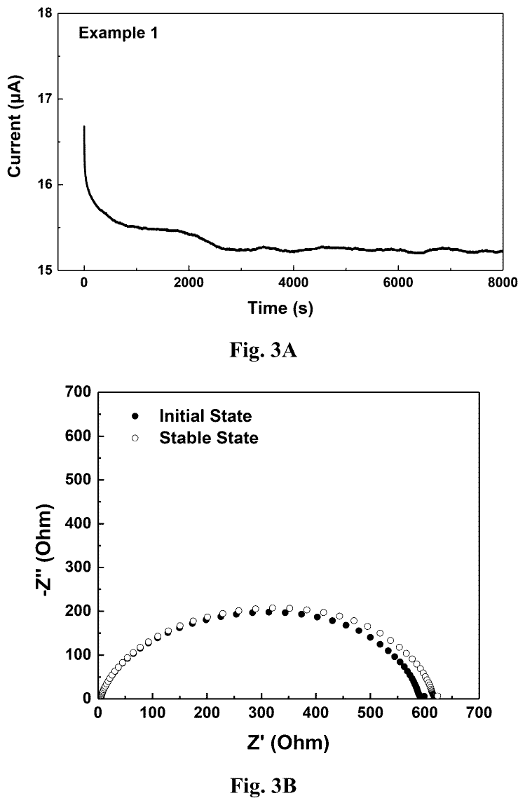

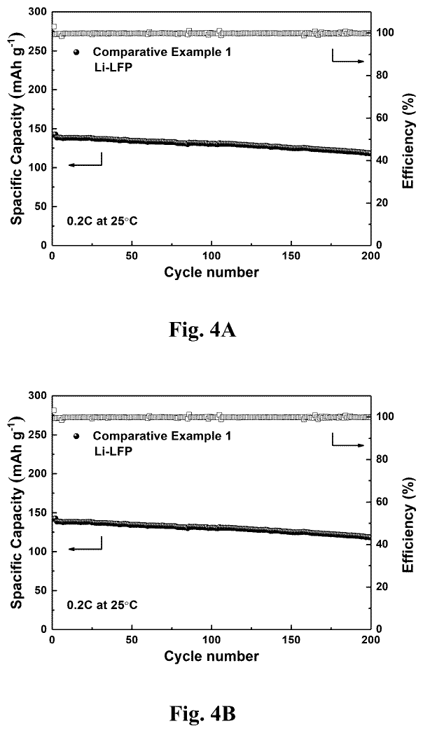

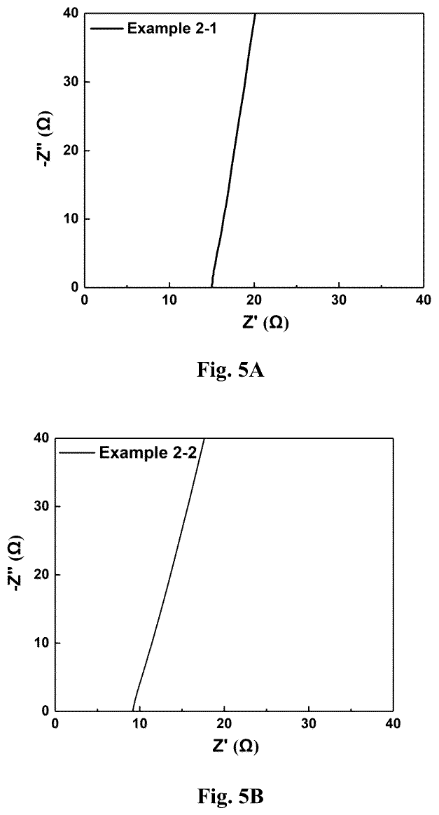

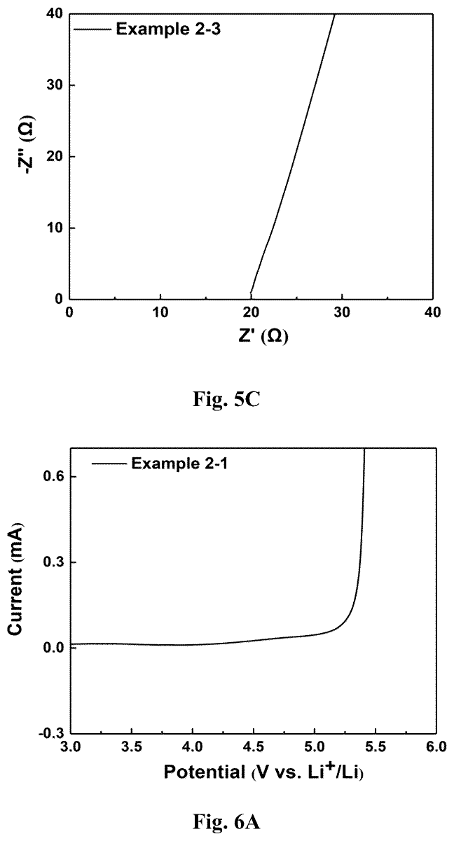

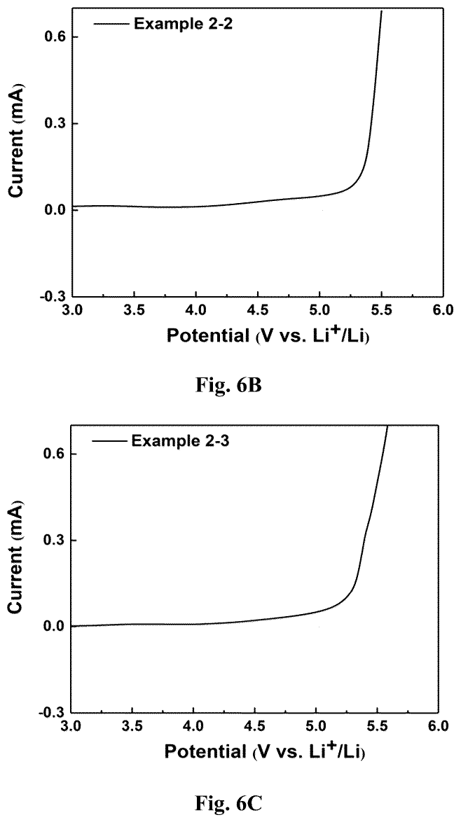

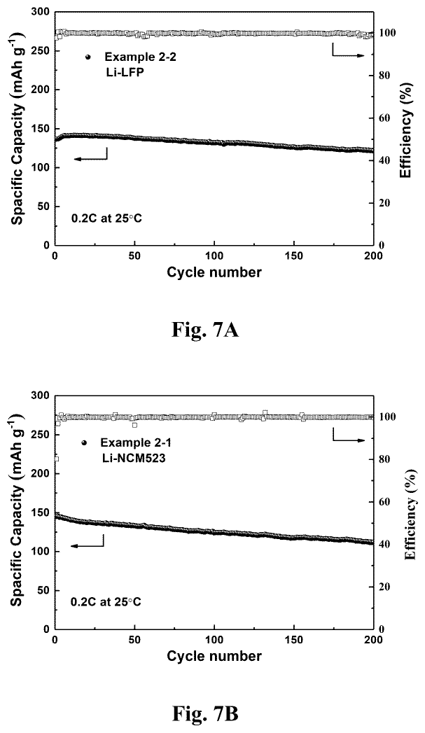

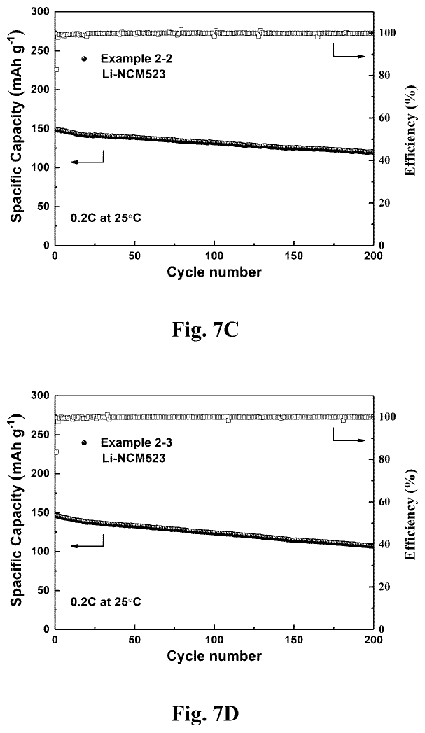

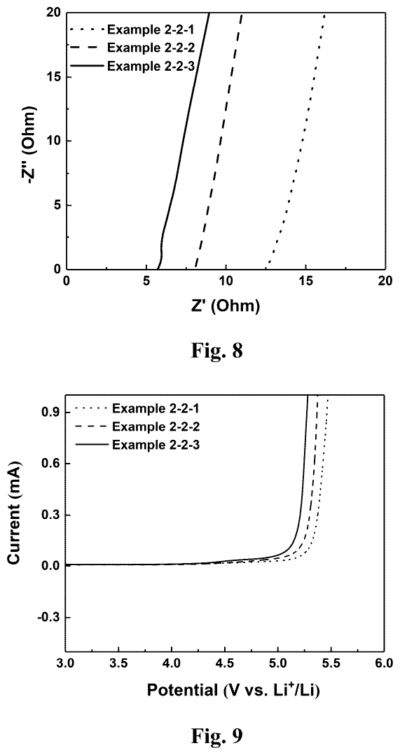

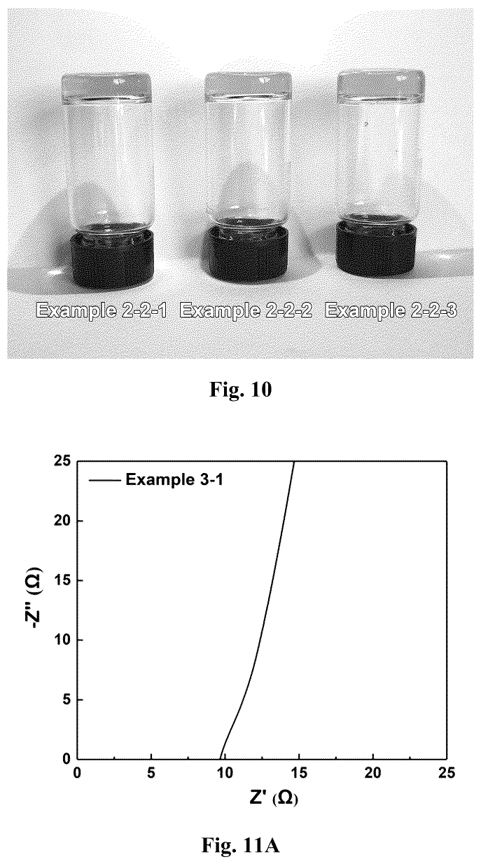

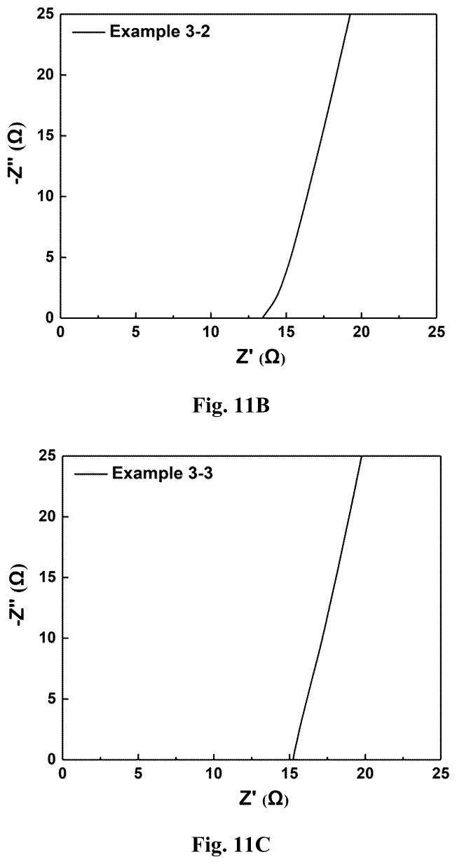

The alternating current (AC) impedance spectroscopy of polymer electrolytes prepared in the examples was performed by a CHI650e electrochemical workstation (Shanghai Chenhua Instruments Co., Ltd., China) at room temperature. The ionic conductivity was measured with SS/polymer electrolyte/SS CR2032 coin cell under an applied voltage of 5 mV and the calculated results by the test are shown in FIG. 1, FIG. 5, FIG. 8, FIG. 11, FIG. 13, FIG. 19 and FIG. 21.

As shown in FIGS. 1 and 13, the ionic conductivity of the electrolyte prepared in Comparative Example 1 was 0.68×10⁻⁴ S cm⁻¹ and that in Comparative Example 4-3 was 0.92×10⁻⁴ S cm⁻¹. The polymer electrolyte according to the present invention showed a higher electrochemical stability window, e.g. 1.79×10⁻⁴ S cm⁻¹ in Example 3-1 and 1.94×10⁻⁴ S cm⁻¹ in Example 2-2, which could contribute to better electrochemical performance.

The ionic conductivity and electrochemical window of PVEC-based polymer electrolytes are summarized in Table 1.

TABLE 1
The ionic conductivity and electrochemical
window of PVEC-based electrolytes

| Silica | | | Ionic | Electro- |
|---|---|---|---|---|
| Concen- | | | conductivity | chemical |
| tration* | Electrolyte | Example | (10⁻⁴ S cm⁻¹) | window |
| 0 wt. % | PVEC | Comparative | 0.68 | 4.8 V |
| | | Example 1 | | |
| 5 wt. % | PVEC + | Example 2-1 | 1.17 | 5.1 V |
| | Nanocryl ® A | | | |
| | 223 | | | |
| | PVEC + | Example 3-1 | 1.79 | 5.0 V |
| | evaporated | | | |
| | Nanopol ® A | | | |
| | 720 | | | |
| | PVEC + | Example 5-1 | 1.20 | 5.0 V |
| | Nanocryl ® A | | | |
| | 235 | | | |
| 7 wt. % | PVEC + | Example 4-1 | 1.72 | 5.1 V |
| | Nanocryl ® A | | | |
| | 223 | | | |
| | PVEC + | Example 4-2 | 1.15 | 5.0 V |
| | evaporated | | | |
| | Nanopol ® A | | | |
| | 720 | | | |
| | PVEC + | Comparative | 0.92 | 5.0 V |
| | fumed SiO₂ | Example 4-3 | | |
| 10 wt. % | PVEC + | Example 2-2 | 1.94 | 5.1 V |
| | Nanocryl ® A | | | |
| | 223 | | | |
| | PVEC + | Example 3-2 | 1.28 | 5.0 V |
| | evaporated | | | |
| | Nanopol ® A | | | |
| | 720 | | | |
| | PVEC + | Example 5-2 | 0.93 | 5.0 V |
| | Nanocryl ® A | | | |
| | 235 | | | |
| | PVEC + | Comparative | | |
| | fumed SiO₂ | Example 4-4 | | |
| 15 wt. % | PVEC + | Example 2-3 | 0.79 | 5.1 V |
| | Nanocryl ® A | | | |
| | 223 | | | |
| | PVEC + | Example 3-3 | 1.14 | 5.0 V |
| | evaporated | | | |
| | Nanopol ® A | | | |
| | 720 | | | |
| | PVEC + | Example 5-3 | 0.43 | 5.0 V |
| | Nanocryl ® A | | | |
| | 235 | | | |
| | PVEC + | Comparative | | |
| | fumed SiO₂ | Example 4-5 | | |

*“Silica Concentration” in the tables of the description refers to the weight percentage of silica particles in the total weight of silica composition (component A) and the monomer of the polymer (component B).

### 3. Lithium Ion Transference Number (LTN)

The lithium ion transference number of polymer electrolytes prepared in examples was performed by a CHI650e electrochemical workstation (Shanghai Chenhua Instruments Co., Ltd., China) at room temperature using symmetric Li/polymer electrolyte/Li cells, as shown in FIG. 15, FIG. 16 and FIG. 17. From Bruce-Vincent-Evans equation, the lithium ion transference numbers of PVEC+Nanocryl® A 223 polymer electrolyte (0.40, Example 4-1) and PVEC+Nanopol® A 720 polymer electrolyte (0.32, Example 4-2), which were higher than that of PVEC+fumed SiO₂ polymer electrolyte (0.31, Comparative Example 4-3), and PVEC polymer electrolyte (0.23, Comparative Example 1) and traditional PEO-based polymer electrolyte (≈0.2, W. Gorecki, M. Jeannin, E. Belorizky, C. Roux, M. Armand, J. Phys.: Condens. Matter 1995, 7, 6823.) were obtained. The results on lithium ion transference number show that the polymer electrolytes with the silica composition, especially the colloidal silica dispersion have a higher value of LTN, which means more free lithium ions existed in polymer electrolyte. It is known that high LTN is more beneficial to the stability of the electrolyte and the rate performance of solid-state lithium metal secondary batteries.

### 4. Characterization of the Morphologies of the Polymer Electrolyte

Scanning electron microscope (SEM) was further conducted to analyze the surficial (FIG. 23(a-d)) and cross-sectional (FIG. 23(e-h)) morphologies of polymer electrolytes prepared in Comparative Example 1, Example 2-2, Example 3-2 and Comparative Example 4-3. The polymer electrolytes were disassembled from coin cells and then were cut into small pieces for SEM test.

As can be seen from FIG. 23(a-d), obvious cracks can be observed on the surface of PVEC electrolyte (Comparative Example 1, FIG. 23d), while few cracks can be seen in PVCE+Nanopol® A 720 electrolyte (Example 3-2, FIG. 23c) and completely disappeared in PVEC+Nanocryl® A 223 electrolyte (Example 2-2, FIG. 23b). In addition, part of the fibers in cellulose separator were not completely wrapped by polymer due to the incomplete polymerization after adding fumed silica in PVEC PVEC+fumed SiO₂ (Comparative Example 4-3, FIG. 23d). Moreover, agglomeration of silica can be observed in the enlarged inset image of FIG. 23d (some places of cellulose matrix have no silica and some places have lots of silica agglomerated together). As shown in the cross-sectional images in FIG. 23(e-h), the thickness of the obtained polymer electrolyte for Comparative Example 1, Comparative Example 4-3, Example 2-2 and Example 3-2 was 58 μm, 64 μm, 46 μm and 35 μm respectively. The polymer electrolyte of the invention (e.g. Example 2-2) showed the least thickness, which is beneficial for improving the energy densities for batteries.

### 5. Cycle Performance of the Electrolyte

The cycle performance of cells prepared in the examples was evaluated by using LiNi₅Co₂Mn₃/LiFePO₄ as the cathode and Li metal as the anode at room temperature on a LAND battery testing system (Wuhan Kingnuo Electronics Co., Ltd., China). The cut-off voltage was 4.3V/4.2 V versus Li/Li⁺ for charge (Li extraction) and 2.7V/2.4 V versus Li/Li⁺ for discharge (Li insertion). All the related cells would be activated by a small current before cycling. The C rates in all of the electrochemical measurements was 0.2 C, defined based on 1 C=160 mA g⁻¹. The test results are shown in FIG. 4, FIG. 7 and FIG. 18. In each figure, the solid points represent discharge capacity and the hollow points represents coulombic efficiency.

For Li—LiFePO₄ cells in FIG. 4 and FIG. 7, the capacity retention after cycled for 200 times of Example 2-2 was 89.9%, slightly higher than the 85.5% of Comparative Example 1, and the coulombic efficiency of the electrolytes of Example 2-2 was >99%. However, the differences between capacity retention were larger, when using the high-voltage LiNi_{0.5}Co_{0.2}Mn_{0.3}O₂ cathode as shown in FIG. 4 and FIG. 7. The capacity retention after cycled for 200 times of the cells of Example 2-1, Example 2-2 and Example 2-3 were 76.9%, 80.3% and 73.1% respectively, which were all higher than the 63.91% of Comparative Example 1.

The comparison of the cycle performance with LiNi_{0.5}Co_{0.2}Mn_{0.3}O₂ cathode for PVEC polymer electrolytes under the same concentration (7 wt. %) of fillers is shown in FIG. 18. The polymer electrolytes of the invention showed better cycle performance than conventional PVEC polymer electrolyte or PVEC polymer electrolyte with fumed silica as filler. The capacity retentions for Example 4-1, Example 4-2 and Comparative Example 4-3 after 200 cycles were 78.13%, 70.82% and 0.00%, respectively. The polymer electrolyte with the commercial fumed silica of Comparative Example 4-3 exhibited poor cycle performance due the poor compatibility of the filler in the PVEC polymer electrolyte.

The cycle performance of PVEC-based polymer electrolytes is summarized in Table 2.

TABLE 2
Cycle performance of PVEC-based polymer electrolytes.

| Silica | | | Capacity retention (after 200 cycles) | |
|---|---|---|---|---|
| Concentration | Electrolyte | Examples | Li—LiNi_{0.5}Co_{0.2}Mn_{0.3}O₂ | Li—LiFePO₄ |
| 0 wt. % | PVEC | Comparative | 63.91% | 85.50% |
| | | Example 1 | | |
| 5 wt. % | PVEC + | Example 2-1 | 76.88% | |
| | Nanocryl ® A | | | |
| | 223 | | | |
| 10 wt. % | PVEC + | Example 2-2 | 80.55% | 89.29% |
| | Nanocryl ® A | | | |
| | 223 | | | |
| 15 wt. % | PVEC + | Example 2-3 | 73.08% | |
| | Nanocryl ® A | | | |
| | 223 | | | |
| 7 wt. % | PVEC + | Example 4-1 | 78.13% | |
| | Nanocryl ® A | | | |
| | 223 | | | |
| | PVEC + | Example 4-2 | 70.82% | |
| | evaporated | | | |
| | Nanopol ® A | | | |
| | 720 | | | |
| | PVEC + | Comparative | 0% | |
| | fumed SiO₂ | Example 4-1 | | |

6. During preparation of the solid polymer electrolytes of the invention including Examples 1-5, the monomer solution, e.g. VEC and PEO, after dispersed with high amount of silica nanoparticles was still in a homogenous and transparent state, which indicates that the surface-modified colloidal silica nanoparticles exhibited excellent dispersion in solid polymer electrolytes. In addition, the solid polymer electrolyte showed no agglomeration, which indicates that the surface-modified colloidal silica nanoparticles of the invention exhibited good polymer-filler interaction in solid polymer electrolytes. The inventors believe that such good properties help to obtain solid polymer electrolytes with improved performance of Li-ion batteries.

In the following Comparative Example 6-1, Comparative Example 6-2 and Example 6-3, poly(ethylene oxide) (PEO)-based electrolytes were prepared.

### Poly(Ethylene Oxide) (PEO) Electrolytes

### Comparative Example 6-1

### 1) Preparation of PEO Solid Polymer Electrolyte:

9.5 g acetonitrile (AN), 0.5 g poly(ethylene oxide) (PEO, viscosity-average molecular weight (Mv)=1,000,000) and 0.2657 g LiFSI were mixed and stirred at 25° C. for 12 h to obtain a homogeneous polymer solution. Thin films of the PEO solid polymer electrolytes, typically 60-90 μm thick, were prepared by casting the gelatinous polymer solution inside a Teflon plate. The samples were initially dried at 25° C. and then transferred to a vacuum oven for final drying at 60° C. for 12 h.

2) CR2032 battery was assembled using solid polymer electrolyte without separator.

### Comparative Example 6-2

### 1) Preparation of PEO/Nanoparticles Solid Polymer Electrolyte:

9.5 g acetonitrile (AN), 0.5 g poly(ethylene oxide) (PEO, molecular weight=1,000,000), 0.05 g fumed silica (Hydrophilic-300, with particle size of 7-40 nm, Aladdin Industrial Inc., China) and 0.2657 g LiFSI were mixed and stirred at 25° C. for 12 h to obtain a polymer solution. Thin films of the PEO solid polymer electrolytes, typically 60-90 μm thick, were prepared by casting the gelatinous polymer solution inside a Teflon plate. The samples were initially dried at 25° C. and then transferred to a vacuum oven for final drying at 60° C. for 12 h.

2) CR2032 battery was assembled using solid polymer electrolyte without separator.

### PEO-Evaporated Nanopol® A 720 Nanoparticles Hybrid Electrolyte

### Example 6-3

### 1) Preparation of PEO/Nanoparticles Solid Polymer Electrolyte:

9.5 g acetonitrile (AN), 0.5 g poly(ethylene oxide) (PEO, molecular weight=1,000,000), 0.05 g evaporated Nanopol® A 720 (solid silica after removing the solvent at 80° C. under vacuum for 48 h) and 0.2657 g LiFSI were mixed and stirred at 25° C. for 12 h to obtain a homogeneous polymer solution. Thin films of the PEO solid polymer electrolytes, 60-90 μm thick, were prepared by casting the gelatinous polymer solution inside a Teflon plate. The samples were initially dried at 25° C. and then transferred to a vacuum oven for final drying at 60° C. for 12 h.

2) CR2032 battery was assembled using solid polymer electrolyte without separator.

### Performance Test

### Ionic Conductivity and Electrochemical Window

The Ionic conductivity and electrochemical window were tested with the same protocols as above. The testing results are shown in FIG. 21 and FIG. 22. The testing results are also summarized in Table 3.

TABLE 3
Ionic conductivity and electrochemical
window of PEO-based electrolytes

| Silica | | | Ionic | Electro- |
|---|---|---|---|---|
| Concen- | | | conductivity | chemical |
| tration | Electrolyte | Example | (10⁻⁴ S cm⁻¹) | window |
| 0 wt. % | PEO | Comparative | 0.17 | 3.9 V |
| | | Example 6-1 | | |
| 10 wt. % | PEO + | Comparative | 0.20 | 4.1 V |
| | fumed SiO₂ | Example 6-2 | | |
| | PEO + | Example 6-3 | 0.98 | 4.3 V |
| | evaporated | | | |
| | Nanopol ® A | | | |
| | 720 | | | |

Compared with tradition PEO-based polymer electrolyte of Comparative Example 6-1 (0.17×10⁻⁴ S cm⁻¹, 3.9 V) and that with commercial fumed silica of Comparative Example 6-2 (0.20×10⁻⁴ S cm⁻¹, 4.1 V), the solid polymer electrolyte using evaporated Nanopol® A 720 of the invention exhibited much higher ionic conductivity and wider electrochemical window (0.98×10⁻⁴ S cm⁻¹, 4.3 V).

As used herein, terms such as “comprise(s)” and the like as used herein are open terms meaning “including at least” unless otherwise specifically noted.

All references, tests, standards, documents, publications, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown but is to be accorded the widest scope consistent with the principles and features disclosed herein. In this regard, certain embodiments within the invention may not show every benefit of the invention, considered broadly.

1. A method for preparation of a solid polymer electrolyte, the method comprising:
preparing the solid polymer electrolyte with a silica composition wherein the silica composition comprises:
a surface-modified colloidal silica dispersion, or an evaporated product of the dispersion.

2. The method of claim 1, wherein the average particle size of the silica is between 3 and 50 nm.

3. The method of claim 1, wherein the average particle size of the silica is measured by small-angle neutron scattering.

4. The method of claim 1, wherein the silica composition is:
a colloidal silica dispersion comprising
a) surface-modified silica particles, and
b) a polymerizable solvent, which is selected from monomers, oligomers and/or prepolymers convertible to polymers by nonradical or radical reactions;
or
an evaporated product of a surface-modified colloidal silica dispersion comprising
a) surface-modified silica particles, and
b′) a non-polymerizable volatile organic solvent;
wherein the average particle size of the silica is between 3 and 50 nm.

5. The method of claim 1, wherein the silica composition is a silica dispersion, which comprises:
aa) an external fluid phase comprising
aa1) polymerizable monomers, oligomers and/or prepolymers convertible to polymers by nonradical reactions;
and/or
aa2) polymers,
bb) a disperse phase comprising colloidal silica, and the average particle size of the silica as measured by small-angle neutron scattering (SANS) is between 3 and 50 nm at a maximum half-width of the distribution curve of 1.5dₘₐₓ.

6. A polymer electrolyte precursor composition for preparation of a solid polymer electrolyte, wherein the polymer electrolyte precursor composition comprises:
A) a silica composition comprising a surface-modified colloidal silica dispersion, or an evaporated product of the dispersion; and
B) the monomer of the polymer.

7. The polymer electrolyte precursor composition of claim 6, wherein the polymer electrolyte precursor composition further comprises:
C) a free radical initiator for polymerization reaction of the monomer; and
D) a lithium salt; and optionally
E) an organic solvent.

8. The polymer electrolyte precursor composition of claim 6, wherein the silica composition is
a colloidal silica dispersion, which comprises:
a) surface-modified silica particles, and
b) a polymerizable solvent, which is selected from monomers, oligomers and/or prepolymers convertible to polymers by nonradical or radical reactions;
or
an evaporated product of a surface-modified colloidal silica dispersion comprising:
a) surface-modified silica particles, and
b′) a non-polymerizable volatile organic solvent;
wherein the average particle size of the silica is between 3 and 50 nm.

9. A method for the preparation of a solid polymer electrolyte, the method comprising:
preparing the solid polymer electrolyte with the polymer electrolyte precursor composition according to claim 6.

10. A method to in-situ prepare a solid polymer electrolyte, wherein the method comprises:
1) injecting the polymer electrolyte precursor composition according to claim 6 into a battery case, followed by sealing; and
2) polymerizing in-situ the polymer electrolyte precursor composition.

11. A method to improve performance of a lithium-ion battery comprising a solid polymer electrolyte, the method comprising:
preparing a solid polymer electrolyte according to the method of claim 1.

12. A method to prepare a solid polymer electrolyte, the method comprising: applying the polymer electrolyte precursor composition according to claim 6.

13. A solid polymer electrolyte, comprising silica particles, wherein
the average particle size of the silica is between 3 and 50 nm, and wherein the silica is organically surface modified wherein the surface modified silica is homogeneously dispersed in the electrolyte; or
wherein the solid polymer electrolyte is prepared according to the method to prepare a solid polymer electrolyte according to claim 10.

14. The solid polymer electrolyte of claim 13, wherein the amount of the silica is from 0.1 wt. % to 26 wt % based on the total weight of the solid polymer electrolyte.

15. The solid polymer electrolyte of claim 13, wherein the solid polymer electrolyte is prepared by crosslinking
the monomer of the polymer and
a polymerizable solvent, which is selected from polymerizable monomers, oligomers and/or prepolymers convertible to polymers by nonradical reactions,
the solid polymer electrolyte further comprises from 0.1-35 wt. % of an organic solvent based on the weight of the monomer of the polymer.

16. An electrochemical device, comprising the solid polymer electrolyte of claim 13.

17. A device, comprising:
the electrochemical device according to claim 16.
